(19) United States
(12) Patent Application Publication
(10) Pub. No.: US 2010/0328811 A1
(43) Pub. Date: Dec. 30, 2010

(54) METHOD OF CONTROLLING READING OR WRITING OPERATION OF DISK DRIVE

(75) Inventor: Jong-yun YUN, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd, Suwon-si (KR)

(21) Appl. No.: 12/824,914

(22) Filed: Jun. 28, 2010

(30) Foreign Application Priority Data
Jun. 29, 2009 (KR) 2009-58317

(51) Int. Cl. G11B 21/02

(52) U.S. Cl. 360/75; G9B/21.003

(57) ABSTRACT

A method of controlling a writing or reading operation of a disk drive. The method includes determining whether a writing control signal or a reading control signal, and a flying height control signal to control a flying height of a head are in enabled states, and when the writing control signal or the reading control signal and the flying height control signal are in the enabled states, performing the writing operation or the reading operation.

### CROSS-REFERENCE TO RELATED APPLICATIONS

This application claims priority under Korean Patent Application No. 10-2009-0058317, filed on Jun. 29, 2009, in the Korean Intellectual Property Office, the disclosure of which is incorporated herein in its entirety by reference.

### BACKGROUND

1. Field of the Invention

The present general inventive concept relates to a method of controlling a disk drive, and more particularly, to a method of controlling a reading operation or a writing operation of a disk drive.

2. Description of the Related Art

In general, disk drives, that is, data storage devices, contribute to operation of a computer system by reproducing data recorded on a disk or recording user data in the disk using a head. As disk drives have higher capabilities, higher densities and smaller sizes, a bit per inch (BPI), that is, a density in a rotary direction of the disk, and a track per inch (TPI), that is, a density in a radial direction of the disk, are being increased, and accordingly, a fine mechanism to control the disk drives is required.

### SUMMARY

Example embodiments of the present general inventive concept can be achieved by providing a method of controlling a writing or reading operation of a disk drive, the method including determining whether a writing control signal or a reading control signal and a flying height control signal to control a flying height of a head are in enabled states, and when the writing control signal or the reading control signal and the flying height control signal are in the enabled states, performing the writing operation or the reading operation.

The method may further include controlling the flying height control signal to be in the enabled state without performing the writing operation or the reading operation, when the reading control signal or the writing control signal is in the enabled state and the flying height control signal is in a disabled state.

Additional embodiments of the present general inventive concept will be set forth in part in the description which follows and, in part, will be obvious from the description, or may be learned by practice of the general inventive concept.

Example embodiments of the present general inventive concept can also be achieved by providing a method of controlling a writing or reading operation of a disk drive, the method including determining whether a writing control signal or a reading control signal and a flying height control signal to control a flying height of a head are in enabled states, and when the writing control signal or the reading control signal and the flying height control signal are in the enabled states, performing the writing operation or the reading operation and controlling the flying height of the head.

The method may further include controlling the flying height control signal to be in the enabled state without performing the writing operation or the reading operation, when the reading control signal or the writing control signal is in the enabled state and the flying height control signal is in the disabled state.

Example embodiments of the present general inventive concept can also be achieved by providing a method of controlling a writing or reading operation of a disk drive, the method including determining whether a writing control signal or a reading control signal and a flying height control signal to control a flying height of a head are in enabled states, and when the writing control signal or the reading control signal and the flying height control signal are in the enabled states, controlling the flying height of the head.

The method may further include controlling the flying height control signal to be in the enabled state without performing the writing operation or the reading operation, when the reading control signal or the writing control signal is in the enabled state and the flying height control signal is in the disabled state.

Example embodiments of the present general inventive concept can also be achieved by providing a disk drive, including a read/write head to read data from a disk or to write data to the disk, and a controller to control the read/write head to perform a reading or writing operation of the disk according to whether a reading control signal or a writing control signal and a flying height control signal of the read/write head are in enabled states.

The controller can prevent the read/write head from performing the reading or writing operation when the reading control signal or the writing control signal is in the enabled state and the flying height control signal is in a disabled state.

The controller can switch the flying height control signal to the enabled state when the reading control signal or the writing control signal is in the enabled state and the flying height control signal is in a disabled state.

The controller can control the read/write head to perform the reading or writing operation when the reading control signal or the writing control signal is in the enabled state and the flying height control signal has been switched from the disabled state to the enabled state.

The controller can control the flying height of the read/write head when the reading or writing operation is being performed.

The controller can control the flying height of the read/write head and can prevent the read/write head from performing the reading or writing operation when the reading control signal or the writing control signal is in the enabled state and the flying height control signal has been switched from the disabled state to the enabled state.

Example embodiments of the present general inventive concept can also be achieved by providing a controller to control a read/write head of a disk drive, including a first unit to output a reading control signal or a writing control signal to control a reading or writing operation of the read/write head, respectively, and a second unit to output a flying height control signal to control a flying height of the read/write head such that the reading or writing operation is performed when the reading control signal or the writing control signal and the flying height control signal are in enabled states, and to prevent the reading or writing operation from being performed when the reading control signal or the writing control signal is in the enabled state and the flying height control signal is in a disabled state.

The second unit can switch the flying height control signal to the enabled state when the reading control signal or the writing control signal is in the enabled state and the flying height control signal is in the disabled state.

The first unit can control the read/write head to perform the reading operation or the writing operation when the reading control signal or the writing control signal is in the enabled state and the flying height control signal has been switched from the disabled state to the enabled state.

The second unit can control the flying height of the read/write head when the reading or writing operation is being performed.

The second unit can control the flying height of the read/write head and the first unit can prevent the read/write head from performing the reading or writing operation when the reading control signal or the writing control signal is in the enabled state and the flying height control signal has been switched from the disabled state to the enabled state.

### BRIEF DESCRIPTION OF THE DRAWINGS

The above and/or other embodiments of the present general inventive concept will become apparent and more readily appreciated from the following description of the exemplary embodiments, taken in conjunction with the accompanying drawings, in which:

FIG. 1 is a plan view of a head disk assembly in a disk drive according to an embodiment of the present general inventive concept;

FIG. 2 is a block diagram of an electric circuit in the disk drive of FIG. 1, according to an embodiment of the present general inventive concept;

FIG. 3 is a plan view illustrating an enlarged view of a head in the disk drive of FIG. 1;

FIG. 4 is a diagram illustrating movement of the head of FIG. 3 according to supply of electric current to the head;

FIG. 5 is a flowchart illustrating a method of controlling a reading or writing operation of a disk drive according to an embodiment of the present general inventive concept;

FIG. 6 is a flowchart illustrating a method of controlling a reading or writing operation of a disk drive according to another embodiment of the present general inventive concept; and

FIG. 7 is a flowchart illustrating a method of controlling a reading or writing operation of a disk drive according to another embodiment of the present general inventive concept.

### DETAILED DESCRIPTION OF THE EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

In general, a disk drive includes a head disk assembly (HDA) including mechanical elements and an electric circuit, coupled to the HDA.

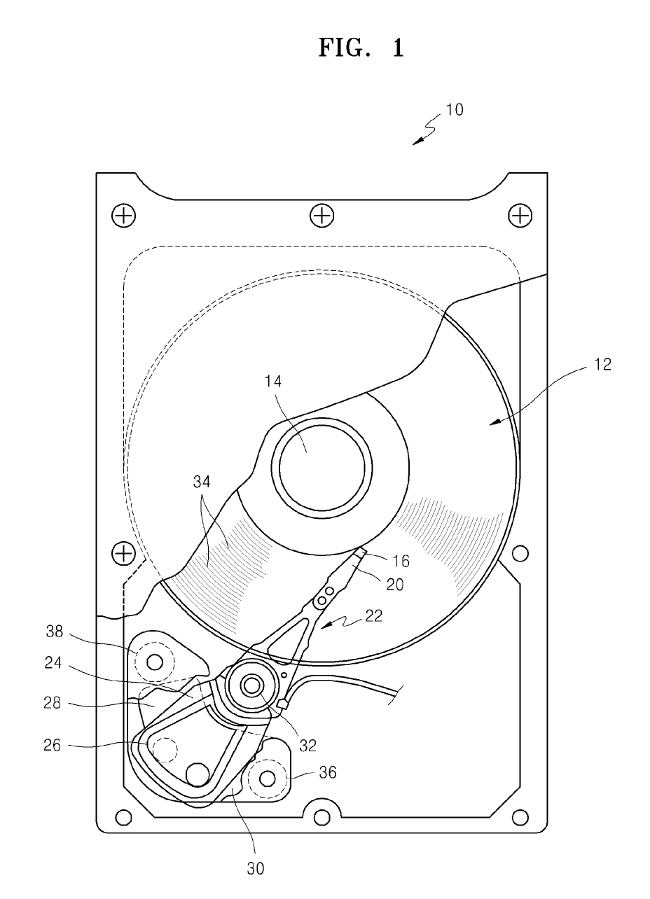

FIG. 1 is a plan view of an HDA 10 of a disk drive according to an example embodiment of the present inventive concept.

Referring to FIG. 1, the HDA 10 includes at least one disk 12 rotated by a spindle motor 14. The HDA 10 also includes a converter (not illustrated) located adjacent to a surface of the disk 12.

The converter senses a magnetic field of the disk 12 or magnetizes the disk 12 to read information from or write information in the disk 12, respectively. Typically, the converter is coupled to the surface of the disk 12. Although the converter is represented as a single converter, it should be understood that the converter includes a writing converter (writer) to magnetize the disk 12, and a reading converter (reader) to sense the magnetic field of the disk 12. The reader includes a magneto-resistive (MR) device.

The converter may be integrated with a magnetic head 16. The magnetic head 16 generates an air bearing between the converter and the surface of the disk 12. The magnetic head 16 is integrated with a head stack assembly (HSA) 22. The HSA 22 may be combined with a head gimbal assembly 20 which is attached to an actuator arm 24 including a voice coil 26. A pair of mounting units 36, 38 may be disposed in the vicinity of a rear end of the HSA to mount the HSA to the HDA. In FIG. 1, the voice coil 26 is adjacent to a magnetic assembly 28 to define a voice coil motor (VCM) 30. An electric current applied to the voice coil 26 can generate a torque to rotate the actuator arm 24 with respect to a bearing assembly 32.

Information (data) is stored in loop tracks 34 of the disk 12. Each of tracks 34 generally includes a plurality of sectors. Each of the sectors typically includes a data field and a servo field. A preamble, a servo address/index mark (SAM/SIM), a gray code, and a burst signal are recorded in the servo field of the disk 12. The converter can move across the surface of the disk 12 in order to read information from or write information in the tracks.

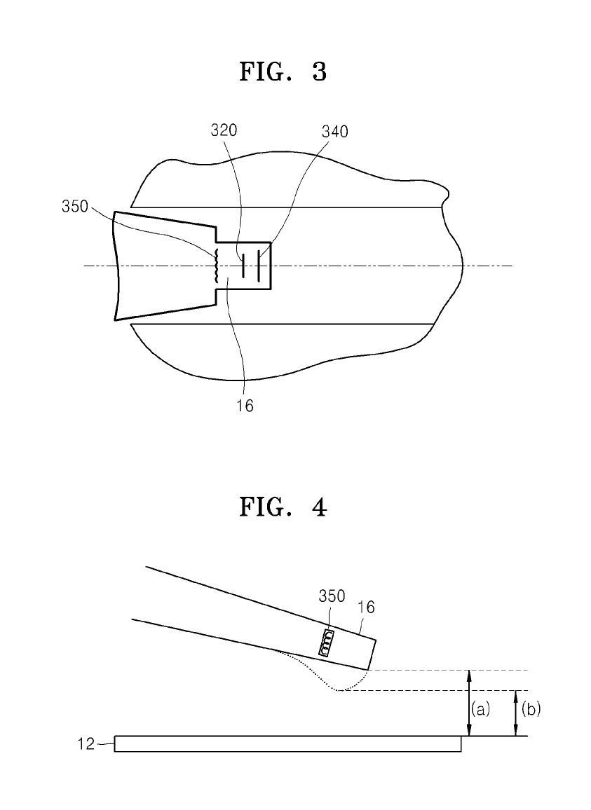

Referring to FIGS. 3 and 4, the magnetic head 16 includes a structure to generate an air bearing surface between the surface of the disk 12 and the reader device 320 and the writer device 340 of the magnetic head 16, including a heater coil 350 to heat the structure to generate the air bearing surface, as described in more detail below in connection with FIGS. 3 and 4.

When a plurality of the disks 12 are mounted in the HDA 10, a plurality of magnetic heads 16 respectively corresponding to surfaces of the disks 12 can be installed. For example, if two of the disks 12 are mounted in the HDA 10, four of the magnetic heads 16 may be mounted on the HSA 22. In addition, each of the plurality of magnetic heads 16 can include the heater 350, respectively. The magnetic head 16 may be referred to as a head.

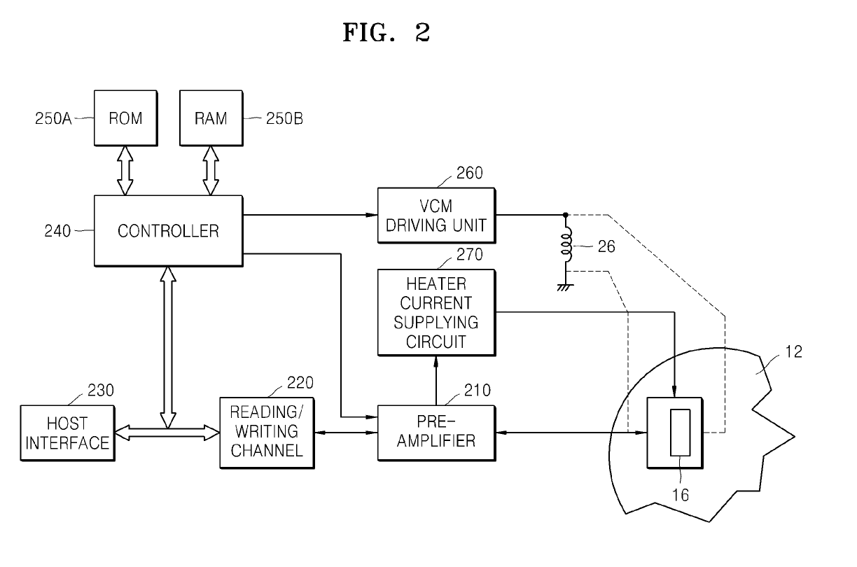

FIG. 2 is a block diagram of an electric circuit of the disk drive according to an example embodiment of the present general inventive concept.

Referring to FIG. 2, the disk drive can include the disk 12, the magnetic head 16, a pre-amplifier 210, a writing/reading channel 220, a host interface 230, a controller 240, a read only memory (ROM) 250A, a random access memory (RAM) 250B, a VCM driving unit 260, and a heater current supplying circuit 270.

In the example embodiment, the ROM 250A stores firmware and control information to control the disk drive. For example, the RAM 250B stores information that is required to drive the disk drive, and the information is read from the ROM 250A or from the disk 12 at an initial stage of driving the disk drive to control the driving of the disk drive.

In an example embodiment, the controller 240 can analyze a command transmitted from a host device (not illustrated) via the host interface 230, and can perform a controlling operation according to the analyzed result. The controller 240 can transmit controlling signals to the VCM driving circuit 260 in order to control movements of the magnetic head 16. In addition, the controller 240 may output a flight height controlling signal to control the heater current supplying circuit 270 to control the flight height of the magnetic head 16. The flight height controlling signal may be output to the heater current supplying circuit 270 directly or via the pre-amplifier 210.

Exemplary operations of the disk drive will be described as follows in order to explain example embodiments of the present general inventive concept.

In a data reading mode, an electric signal sensed by the reader of the magnetic head 16 from the disk 12 can be amplified by the pre-amplifier 210. In addition, the reading/writing channel 220 can control gain of the electric signal by using an automatic gain control circuit (not illustrated) to amplify the signal amplified by the pre-amplifier 210 to a predetermined level. In addition, the analog signal amplified to a predetermined level by the automatic gain control circuit can be converted to a digital signal that may be read by the host device (not illustrated), and converted into stream data and transmitted to the host device via the host interface 230.

Next, in a writing mode, data transmitted from the host device via the host interface 230 can be converted into a binary data stream that is suitable for a writing channel of the reading/writing channel 220, and then a writing current amplified by the pre-amplifier 210 can be written in the disk 12 by using the writer of the magnetic head 16.

The reading/writing channel 220 provides the controller 240 with information to control track seeking and track following operations while reproducing the preamble, the SAM/SIM, the gray code, and the burst signal recorded in the servo fields of the disk 12. The reading/writing channel 220 provides the controller 240 with the information to control the track seeking and track following operations while reproducing reference servo patterns recorded on a surface of one of a plurality of the disks by using a reference head, in a servo copying operation.

FIG. 3 is a plan view illustrating an enlarged view of the head 16 in the disk drive of FIG. 1.

Referring to FIG. 3, the head 16 may include a writing device 340 and a reading device 320 separated from each other. The writing device 340 magnetizes the disk 12 in order to write data in the disk 12. The reading device 320 senses the magnetic field of the disk 12 in order to read data from the disk 12. For example, the reading device 320 may include a magneto-resistive material having a resistance that linearly varies depending on a change in magnetic flux. The head 16 may include a heater coil 350, and an electric current may be supplied to the heater coil 350 in order to heat the head 16. The heat thermally expands the head 16, and thus the writing and reading devices 320 and 340 are moved closer to the disk 12. As described above, those skilled in the art will appreciate that the technology of controlling the flying height of the head 16 using the heater coil 350 is referred to as flying height on demand (FOD) technology. Exemplary movements of the head 16 according to the FOD technology will be described in more detail with reference to FIG. 4.

FIG. 4 is a diagram illustrating movement of the head 16 of FIG. 3 according to an electric current supplied to the head 16.

Referring to FIG. 4, as described above, the flying height of the head 16 can be changed according to the electric current supplied to the head 16. For example, when a small amount of current is applied to the head 16, that is, to the heater coil 350 of the head 16, the head 16 does not significantly expand and may have a flying height of (a). As the electric current applied to the heater coil 350 of the head 16 increases, the head 16 expands, and thus the flying height of the head 16 may be lowered to (b) from (a). That is, the FOD technology can control the flying height of the head 16 by adjusting the electric current applied to the heater coil 350. The flying height of the head 16 is changed according to the amount of the applied electric current, and accordingly, the reading device or the writing device of the head 16 becomes closer to or farther from the disk 12.

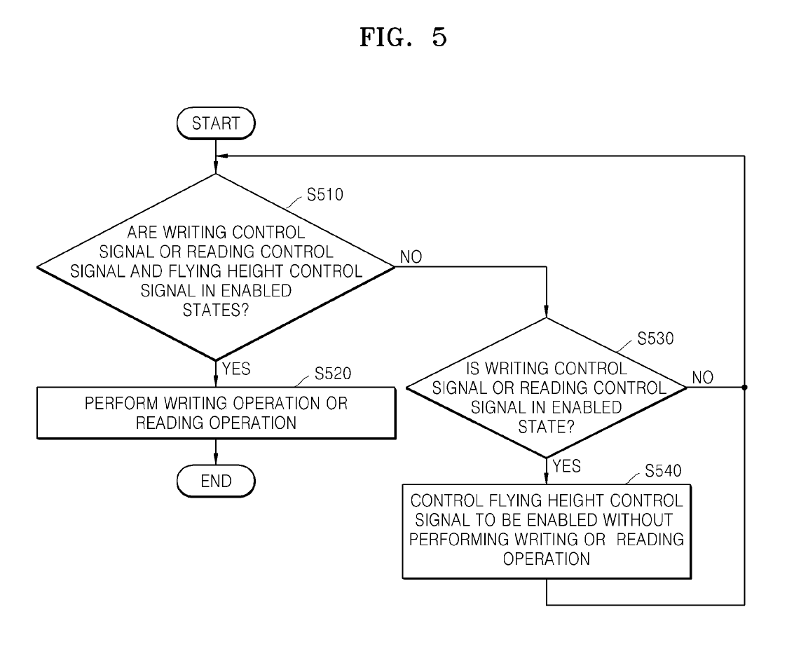

FIG. 5 is a flowchart illustrating a method of controlling a writing or reading operation of the disk drive according to an example embodiment of the present general inventive concept.

The reading or writing operation of the disk drive will be described with reference to FIG. 5. For convenience of description, the writing operation of the disk drive in accordance with an example embodiment of the present general inventive concept will be described first as follows.

Referring to FIG. 5, when the disk drive performs a writing operation, it is identified whether a writing control signal and a flying height control signal are in an enabled state in operation S510. The writing control signal is a signal to control whether the disk drive performs the writing operation. The flying height control signal is a signal to control the flying height of the head 16, and may be an FOD enable signal to control whether an electric current is supplied to the heater coil 350 of the head 16, as described above. However, those skilled in the art will appreciate that the flying height control signal is not limited to the FOD enable signal, but may be any other known or later developed signal to control the flying height of the head 16 when the writing operation is performed. As a result of the determination in operation S510, when the writing control signal and the flying height control signal are both in enabled states, the writing operation is performed in operation S520. If the writing control signal and the flying height signal are not in the enabled states, it is determined whether the writing control signal is in enabled state in operation S530. That is, if the writing control signal is in the enabled state and the flying height control signal is in a disabled state, the writing operation is not performed and the flying height control signal is controlled to be the enabled state in operation S540. In addition, if the writing control signal is in the disabled state, the writing operation of the disk drive is not performed, and accordingly, additional operations are not performed.

The above operations may be performed in the pre-amplifier 210 of FIG. 2. That is, the pre-amplifier 210 may receive the writing control signal and the flying height control signal. In addition, when both of the writing control signal and the flying height control signal are in enabled states, the pre-amplifier 210 may supply a writing current to the head 16 in order to perform the writing operation. Also, the pre-amplifier 210 may output the flying height control signal to the heater current supplying circuit 270 regardless of the state of the writing control signal. As described with reference to FIG. 2, the flying height control signal may be output from the controller 240 to the heater current supplying circuit 270 directly or via the pre-amplifier 210. When the flying height control signal is in the enabled state, the heater current supplying circuit 270 may supply an electric current to the heater coil of the head 16 according to the flying height control signal. If the writing control signal is in the enabled state while the flying height control signal is in the disabled state, the pre-amplifier 210 does not supply the writing current to the head 16, but controls the flying height control signal to be in the enabled state. In addition, the above operations may be performed in another component in the disk drive.

When the reading operation of the disk drive is performed, it is determined whether the reading control signal and the flying height control signal are in the enabled states in operation S510. The reading operation is performed in operation S520 or the flying height control signal is controlled to be in the enabled state without performing the reading operation in operation S540 according to the determination result of operation S510. The reading operation is performed similar to the writing operation described above, and thus, a detailed description of the reading operation is omitted.

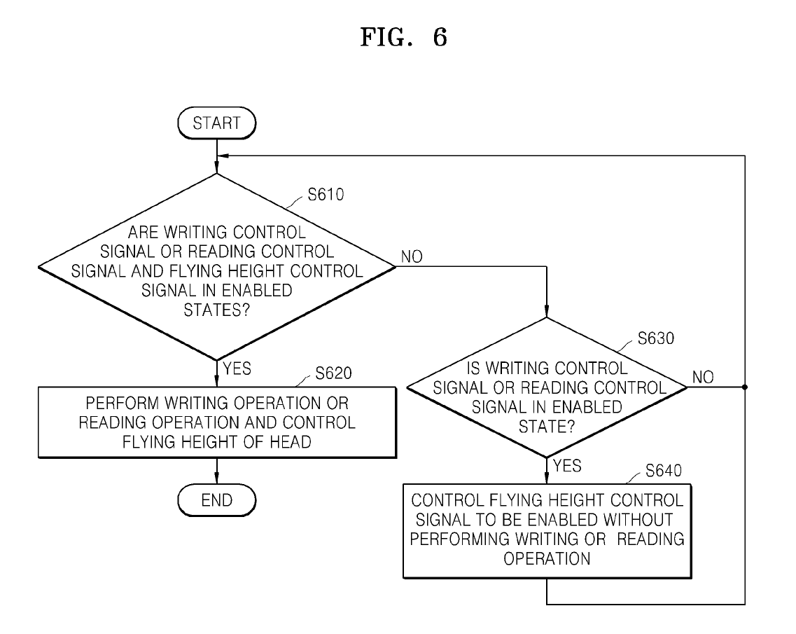

FIG. 6 is a flowchart illustrating a method of controlling a reading or writing operation of a disk drive according to another example embodiment of the present general inventive concept.

The writing or reading operation of the disk drive will be described with reference to the embodiment of FIG. 6. For convenience of description, the writing operation of the disk drive in accordance with this example embodiment will be described first as follows.

Referring to FIG. 6, when the disk drive performs the writing operation, it is determined whether a writing control signal and a flying height control signal are in the enabled states in operation S610. The writing control signal is a signal to control whether the disk drive performs the writing operation. The flying height control signal is a signal to control the flying height of the head 16, and may be an FOD enable signal to control whether the electric current is supplied to the heater coil 350 of the head 16, as described above. However, those skilled in the art will appreciate that the flying height control signal is not limited to the FOD enable signal, but may be any other known or later developed signal to control the flying height of the head 16 when the writing operation is performed. As a result of the determination in operation S610, when the writing control signal and the flying height control signal are both in the enabled states, the writing operation is performed and the flying height of the head 16 is controlled in operation S620. If the writing control signal and the flying height signal are not in the enabled state, it is determined whether the writing control signal is in the enabled state in operation S630. That is, if the writing control signal is in the enabled state and the flying height control signal is in the disabled state, the writing operation is not performed and the flying height control signal is controlled to be in the enabled state in operation S640. In addition, if the writing control signal is in the disabled state, the writing operation of the disk drive is not performed, and accordingly, additional operations are not performed.

The above operations may be performed in the pre-amplifier 210 of FIG. 2. That is, the pre-amplifier 210 may receive the writing control signal and the flying height control signal. In addition, when both of the writing control signal and the flying height control signal are in the enabled states, the pre-amplifier 210 may supply a writing current to the head 16 in order to perform the writing operation. Also, the pre-amplifier 210 may output the flying height control signal to the heater current supplying circuit 270 when both of the writing control signal and the flying height control signal are in the enabled states. When the flying height control signal is in the enabled state, the heater current supplying circuit 270 may supply an electric current to the heater coil 350 of the head 16 according to the flying height control signal. If the writing control signal is in the enabled state while the flying height control signal is in the disabled state, the pre-amplifier 210 does not supply the writing current to the head 16, but controls the flying height control signal to be in the enabled state. In addition, the above operations may be performed in another component in the disk drive.

When the reading operation of the disk drive is performed, it is determined whether the reading control signal and the flying height control signal are in the enabled states in operation S610. The reading operation is performed in operation S620 or the flying height control signal is controlled to be in the enabled state without performing the reading operation in operation S640 according to the determination result of operation S610. The reading operation is performed similar to the writing operation described above, and thus, a detailed description of the reading operation is omitted.

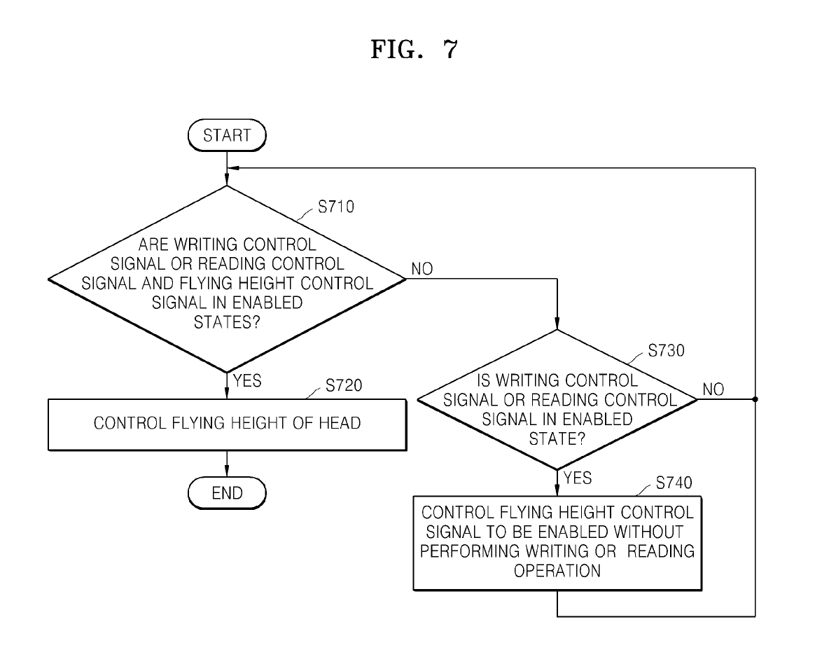

FIG. 7 is a flowchart illustrating a method of controlling a writing or reading operation of a disk drive according to another example embodiment of the present general inventive concept.

The writing or reading operation of the disk drive will be described with reference to the embodiment of FIG. 7. For convenience of description, the writing operation of the disk drive in accordance with this example embodiment will be described first as follows.

When the disk drive performs the writing operation, it is determined whether a writing control signal and a flying height control signal are in the enabled states in operation S710. The writing control signal is a signal to control whether the disk drive performs the writing operation. The flying height control signal is a signal to control the flying height of the head 16, and may be an FOD enable signal to control whether the electric current is supplied to the heater coil 350 of the head 16 or not, as described above. However, those skilled in the art will appreciate that the flying height control signal is not limited to the FOD enable signal, but may be any other known or later developed signal to control the flying height of the head 16 when the writing operation is performed. As a result of determination in operation S710, when the writing control signal and the flying height control signal are both in the enabled states, the flying height of the head 16 is controlled in operation S720. If the writing control signal and the flying height signal are not in the enabled state, it is determined whether the writing control signal is in the enabled state in operation S730. That is, if the writing control signal is in the enabled state and the flying height control signal is in the disabled state, the writing operation is not performed and the flying height control signal is controlled to be in the enabled state in operation S740. In addition, if the writing control signal is in the disabled state, the writing operation of the disk drive is not performed, and accordingly, additional operations are not performed.

The above operations may be performed in the pre-amplifier 210 of FIG. 2. That is, the pre-amplifier 210 can receive the writing control signal and the flying height control signal. In addition, when both of the writing control signal and the flying height control signal are in the enabled states, the pre-amplifier 210 may output the flying height control signal to the heater current supplying circuit 270. If the flying height control signal is in the enabled state, the heater current supplying circuit 270 may supply an electric current to the heater coil 350 of the head 16 according to the flying height control signal. If the writing control signal is in the enabled state while the flying height control signal is in the disabled state, the pre-amplifier 210 does not supply the writing current to the head 16, but controls the flying height control signal to be in the enabled state. In addition, the above operations may be performed in another component in the disk drive.

When the reading operation of the disk drive is performed, it is determined whether the reading control signal and the flying height control signal are in the enabled states in operation S710. The flying height of the head 16 is controlled in operation S720 or the flying height control signal is controlled to be in the enabled state without performing the reading operation in operation S740 according to the determination result of operation S710. The reading operation is performed similar to the writing operation described above, and thus, detailed description of the reading operation is omitted.

Although a few embodiments of the present general inventive concept have been illustrated and described, it would be appreciated by those skilled in the art that changes may be made in these embodiments without departing from the principles and spirit of the general inventive concept, the scope of which is defined in the claims and their equivalents.

What is claimed is:

1. A method of controlling a writing or reading operation of a disk drive, the method comprising:
determining whether a writing control signal or a reading control signal, and a flying height control signal to control a flying height of a head are in enabled states; and
when the writing control signal or the reading control signal and the flying height control signal are in the enabled states, performing the writing operation or the reading operation.

2. The method of claim 1, further comprising controlling the flying height control signal to be in the enabled state without performing the writing operation or the reading operation, when the reading control signal or the writing control signal is in the enabled state and the flying height control signal is in a disabled state.

3. The method of claim 1, wherein the flying height control signal is a flying height on demand (FOD) enable signal to control whether electric current is supplied to a heater coil of the head.

4. The method of claim 1, wherein the performing the writing operation or the reading operation is when the writing control signal or the reading control signal and the flying height control signal are in the enabled states, performing the writing operation or the reading operation and controlling the flying height of the head.

5. The method of claim 4, further comprising controlling the flying height control signal to be in the enabled state without performing the writing operation or the reading operation, when the reading control signal or the writing control signal is in the enabled state and the flying height control signal is in the disabled state.

6. The method of claim 4, wherein the flying height control signal is a flying height on demand (FOD) enable signal to control whether electric current is supplied to a heater coil of the head.

7. A method of controlling a writing or reading operation of a disk drive, the method comprising:
determining whether a writing control signal or a reading control signal, and a flying height control signal to control a flying height of a head are in enabled states; and
when the writing control signal or the reading control signal and the flying height control signal are in the enabled states, controlling the flying height of the head.

8. The method of claim 7, further comprising controlling the flying height control signal to be in the enabled state without performing the writing operation or the reading operation, when the reading control signal or the writing control signal is in the enabled state and the flying height control signal is in the disabled state.

9. The method of claim 7, wherein the flying height control signal is a flying height on demand (FOD) enable signal to control whether electric current is supplied to a heater coil of the head.

10. A disk drive, comprising:
a read/write head to read data from a disk or to write data to the disk; and
a controller to control the read/write head to perform a reading or writing operation of the disk according to whether a reading control signal or a writing control signal and a flying height control signal of the read/write head are in enabled states.

11. The disk drive of claim 10, wherein the controller prevents the read/write head from performing the reading or writing operation when the reading control signal or the writing control signal is in the enabled state and the flying height control signal is in a disabled state.

12. The disk drive of claim 10, wherein the controller switches the flying height control signal to the enabled state when the reading control signal or the writing control signal is in the enabled state and the flying height control signal is in a disabled state.

13. The disk drive of claim 12, wherein the controller controls the read/write head to perform the reading or writing operation when the reading control signal or the writing control signal is in the enabled state and the flying height control signal has been switched from the disabled state to the enabled state.

14. The disk drive of claim 13, wherein the controller controls the flying height of the read/write head when the reading or writing operation is being performed.

15. The disk drive of claim 12, wherein the controller controls the flying height of the read/write head and prevents the read/write head from performing the reading or writing operation when the reading control signal or the writing control signal is in the enabled state and the flying height control signal has been switched from the disabled state to the enabled state.

16. The disk drive of claim 10, wherein the controller comprises:
a first unit to output the reading control signal or the writing control signal to control the reading or writing operation of the read/write head, respectively; and
a second unit to output the flying height control signal to control a flying height of the read/write head such that the reading or writing operation is performed when the reading control signal or the writing control signal and the flying height control signal are in enabled states, and to prevent the reading or writing operation from being performed when the reading control signal or the writing control signal is in the enabled state and the flying height control signal is in a disabled state.

17. The controller of claim 16, wherein the second unit switches the flying height control signal to the enabled state when the reading control signal or the writing control signal is in the enabled state and the flying height control signal is in the disabled state.

18. The controller of claim 17, wherein the first unit controls the read/write head to perform the reading operation or the writing operation when the reading control signal or the writing control signal is in the enabled state and the flying height control signal has been switched from the disabled state to the enabled state.

19. The controller of claim 18, wherein the second unit controls the flying height of the read/write head when the reading or writing operation is being performed.

20. The controller of claim 17, wherein the second unit controls the flying height of the read/write head and the first unit prevents the read/write head from performing the reading or writing operation when the reading control signal or the writing control signal is in the enabled state and the flying height control signal has been switched from the disabled state to the enabled state.
